(19) United States
(12) Patent Application Publication
(10) Pub. No.: US 2015/0032484 A1
(43) Pub. Date: Jan. 29, 2015

(54) METHOD FOR MAKING RESERVATIONS

(71) Applicant: Yakov Z. Mermelstein, Spring Valley, NY (US)

(72) Inventor: Yakov Z. Mermelstein, Spring Valley, NY (US)

(21) Appl. No.: 13/948,735

(22) Filed: Jul. 23, 2013

(51) Int. Cl. G06Q 10/02

(52) U.S. Cl. CPC G06Q 10/02
USPC 705/5

(57) ABSTRACT

The concept of this invention centers around the “one click” method of initiating action. In particular, the single action being performed is clicking an icon or electronic button or even a voice command. For example, on the screen of the user's personal electronic device when the electronic calendar appears next to each meeting, there is an icon or electronic button for “one click” travel arrangements. By clicking that icon or button, the travel arrangements procedure is started with no further user action.

### FIELD OF THE INVENTION

This invention relates to the travel industry and, more particularly, to a method for automatically making “one click” travel reservations.

### BACKGROUND OF THE INVENTION

In the 21^{st} Century, people are traveling all over the world. It is not like the 17^{th} or 18^{th} century when people rarely left their village and did not travel 100 miles in their entire lifetime.

To travel, one must obtain tickets for transportation and make arrangements for accommodations. For decades, travel agents were at the forefront of obtaining tickets for airlines and other transportation and also for making tour and hotel arrangements. In recent years, people have switched to the Internet to buy their own tickets and to make their own travel arrangements.

Systems do exist for automatically making travel reservations and making bookings. These systems, however, are not totally automatic, as the user must at some point put in the relevant travel information—inter alia, dates, starting point, destination, mode of travel, etc.

Mandelbaum (US Published Patent Application 20110307280) discloses a travel system uses information pertaining to an initial origin and an ultimate destination of a traveler, instead of specific airports (or other travel depots) to plan and book a complete itinerary. The complete itinerary may include transportation, lodging, and/or car rentals for one or more travel legs to/from one or more destinations. In some embodiments, the travel system may import information associated with one or more appointments from the traveler's calendar to automatically plan and book the complete itinerary. According to this system, the user must first input specified information. The booking process does not start simply by “clicking” an entry in an electronic calendar.

Mortimore (US Published Patent Application 20090210261) discloses a method for obtaining a starting point and a destination point for a traveler; identifying multiple options of transportation modes to travel from the starting point to the destination point, and identifying a costs and travel time associated respectively with each transportation mode to travel from a departure terminal to an arrival terminal; identifying respectively for each transportation mode, a costs and travel time associated with local transportation from the starting point to a departure terminal, and identifying a costs and travel time associated with local transportation from an arrival terminal to the destination point; presenting to the traveler for selection, the multiple options of transportation modes to travel from the starting point to the destination point, including costs and travel time associated respectively with each option of transportation mode, including local transportation from the starting point to the departure terminal, from the departure terminal to the arrival terminal, and local transportation from the arrival terminal to the destination point; receiving a selection of a transportation mode and reserving the transportation associated with the respective transportation mode. Basically, it is a method for factoring in the time and cost of different travel options.

Gupta (US Published Patent Application 20100094668) discloses a method for making a reservation associated with a calendar appointment. The method includes monitoring a calendar application for reservation type appointments. In response to identifying a reservation type appointment, the method determines whether a network reservation may be made with a service provider associated with the reservation type appointment. If a network reservation may be made with the service provider, the method automatically enters in information for making the network reservation with data retrieved from the reservation type appointment and submitting the network reservation to the service provider. This method suffers from the problem that the reservation process starts without user action, so it may result in making reservations and bookings that the user does not need or want.

Bonev (US Published Patent Application 20090216569) discloses a system including a database storing user data including user preferences and events in a calendar of a system user; a processor configured to automatically scan the database to determine an event scheduled for a predetermined window of time; to automatically determine the event is associated with travel by the user and access one or more travel services, and to prepare content conveying a travel package customized to the event of the user; and a server to serve the content for presentation by the graphical user interface.

Rines (US Published Patent Application 20090210262) discloses that the computer may automatically identify appointment data associated with a scheduling application. The computer automatically researches one or more travel arrangements according to the appointment data.

Ahi (US Published Patent Application 20070260591) discloses a system and method of providing integrated calendaring and concierge services comprising, receiving user data, receiving vendor data, matching user data with vendor data and reporting said matched user data and vendor data, wherein searching and indexing can be conducted based upon any one or number of predetermined factors including geographic location and availability of a desired good and/or service.

Dombroski (US Published Patent Application 20030023463) discloses a system for automatically planning, booking and calendaring travel arrangements includes a data storage device, a booking engine, an output device and a processor. Maintained in the storage device is a database of user profile information. The processor receives a travel request input including travel request data gathered from a user's calendar application. The stored user profile information and the travel request data is used to automatically formulate a travel request in response to the travel request input. The travel request includes airline, hotel and rental car reservation information. A travel query file is automatically created from the travel request. The creation of the travel query file includes: automatically executing an air booking process, based on at least two categories of user preference information selected from the categories of lowest price, arrival/departure time, airline, non-stop, duration, alternate airports and full fare automobile upgrades; automatically executing a car booking process; and automatically executing a hotel booking process. The travel query file is submitted to the booking engine for creating a travel request query. The travel request query is submitted to a travel distribution system for retrieving air, car and hotel availability information. Retrieved air, car and hotel availability information is used to create a suggested travel itinerary, which is outputted for display. The suggested travel itinerary can be manually changed or confirmed. The confirmed travel itinerary can be processed to automatically create and store appointment events in a user's calendar application.

Shah (US Published Patent Application 20020032589) discloses a system and method for integrating calendaring and reservation processes. A user obtains an appointment request. A personal information management application determines whether one or more reservations, including travel reservations, are needed as part of the appointment. Accordingly, the user can accept the appointment request and make the appropriate reservation as a single transaction.

One of the problems with these systems for making travel arrangements is that they either make reservations a person does not need or they require multiple actions and entries by the user. They do not afford the convenience of “one click” booking.

Amazon.com Inc. (U.S. Pat. No. 5,960,411) was one of the pioneers of “one click” purchasing on the Internet. That ease and convenience of “one click” action has not been expanded into the travel industry to allow “one click” booking of travel arrangements.

Therefore, there is a need in the travel industry for a method to automatically make reservations and make bookings, based on a simple “one click” designation on an electronic calendar.

### SUMMARY OF THE INVENTION

These and other objects of the invention are achieved with a simple “once click” designation on an electronic calendar to initiate a process for booking and making travel arrangements.

In one embodiment, the invention involves a simple “one click” designation on an electronic calendar to initiate a process for booking and making travel arrangements.

The concept of this invention centers around the “one click” method of initiating action. In particular, the single action being performed is clicking an icon or electronic button. For example, on the screen of the user's personal electronic device when the electronic calendar appears next to each meeting, there is an icon or electronic button for “one click” travel arrangements. By clicking that icon or button, the travel arrangements procedure is started with no further user action.

According to the Invention, the method of making travel arrangements, comprises: in response to only a single action being performed, designating a meeting with a specified physical location on an electronic calendar for making travel arrangements; identifying existing meetings entered on the electronic calendar that are closest in time to a designated meeting; identifying from the electronic calendar a location of the user for days immediately before and after the designated meeting; calculating travel time to and from the designated meeting from immediately preceding and immediately succeeding existing meetings and from the locations for the days immediately before and after the designated meeting; determining if there is sufficient time to travel to and from the physical location of the designated meeting; determining if there is availability of transportation services at a time needed for travel; and, if there is sufficient time to travel to and from the designated meeting and transportation services are available, automatically making travel arrangements without further user involvement.

According to a preferred embodiment, if the designated meeting is not logistically possible, the system searches the electronic calendar for a time and date wherein there is sufficient time and transportation services to travel to the physical location of the designated meeting.

In a preferred embodiment, the system can alert a user that he has not yet made reservations. More particularly, this part of the method additional includes: identifying meetings on the electronic calendar in physical locations remote to the user; if travel arrangements have not been made for these identified meetings within a pre-specified time prior to the meeting, generating a “pop up” reminder to the user; then the user indicates on the pop up reminder if travel arrangements should be made; and if the user indicates that travel arrangements should be made, automatically making the travel arrangements without further user involvement.

Another embodiment integrates global positioning technology (e.g. GPS) into the system for making reservations. By means of GPS technology, the location of the user is easily determined by determining the location of his personal electronic device. Then the system calculates travel time from the current location and determines if the user can still make the booked travel. If not, the travel is re-booked.

Still another variation of the invention involves instant reservations. For example, a person needs a hotel or restaurant immediately. He can just “one click” an icon or electronic button on the screen of his personal electronic device to start the process. By means of GPS technology the device knows the current location. Then a search is done of the closest hotels (or restaurants or other facilities) and the booking is automatically made.

Another aspect involves ordering local transportation. This may be done at the end of a meeting and/or in advance of a meeting. Since meetings are entered on the user's electronic calendar, the device knows when a meeting is scheduled to end or to begin. At a predetermined time prior to a meeting ending (or prior to a meeting starting) the device generates a Pop Up reminder to the user to inquire if local transportation is needed. If the user indicates yes, then local transportation, such as a taxi, is ordered to meet the user at his current location.

Other objects, features and advantages of the present invention will become apparent upon reading the following detailed description in conjunction with the drawings and the claims.

### BRIEF DESCRIPTION OF THE DRAWINGS

For a better understanding of the invention, its operation and specific objects attained by its uses, reference should be had to accompanying drawings and descriptive matter in which there are illustrated preferred embodiments of the invention.

The invention will now be described in connection with certain preferred embodiments with reference to the following illustrative figures so that it may be more fully understood.

FIGS. 1, 2, 4, 5, 6 and 7 are flow charts, showing the process of the invention.

FIGS. 3A and 3B illustrate standard screens for a personal electronic device.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to the Invention, in its simplest, basic form, it involves a simple “one click” designation on an electronic calendar to initiate a process for booking and making travel arrangements.

For purposes of the invention, the term portable electronic device includes any portable device that may be used for electronic communication, including, but not limited to, mobile devices, cell phones, smart phones, hand held computers, laptop computers, palm top computers, personal digital assistant (PDA), electronic pads and/or tablets.

The term Global Positioning System should also include any communication system that helps the device determine location, and it is not limited to and may include “WIFI,” “Bluetooth,” “NFC” and/or “GPS.”.

In one embodiment, the method of making travel arrangements, comprises: in response to only a single action being performed, designating a meeting with a specified physical location on an electronic calendar for making travel arrangements; identifying existing meetings entered on the electronic calendar that are closest in time to a designated meeting; identifying from the electronic calendar a location of the user for days immediately before and after the designated meeting; calculating travel time to and from the designated meeting from immediately preceding and immediately succeeding existing meetings and from the locations for the days immediately before and after the designated meeting; determining if there is sufficient time to travel to and from the physical location of the designated meeting; determining if there is availability of transportation services at a time needed for travel; and, if there is sufficient time to travel to and from the designated meeting and transportation services are available, automatically making travel arrangements without further user involvement.

The concept of this invention centers around the “one click” method of initiating action. In particular, the single action being performed is clicking an icon or electronic button or even a voice command. For example, on the screen of the user's personal electronic device when the electronic calendar appears next to each meeting, there is an icon or electronic button for “one click” travel arrangements. By clicking that icon or button, the travel arrangements procedure is started with no further user action.

According to the herein claimed method, it involves single-action (i.e. “one click”) booking of transportation arrangements. Single-action booking reduces the number of interactions needed to book travel services. When single-action ordering is enabled, the user need only perform a single action (e.g., click a mouse button) to initiate booking travel arrangements. When the user performs that single action, the internal server system starts the process

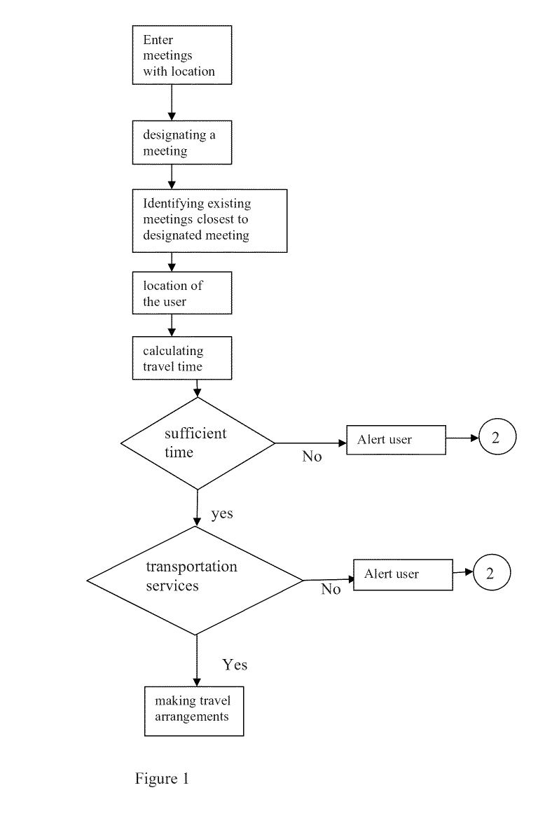

In the preferred embodiment of the invention (FIG. 1), one first must obviously have an electronic calendar which lists meetings, including the physical location of the meeting. For this purpose any standard electronic calendar may be used, such as Google® Calendar or Microsoft® Outlook.

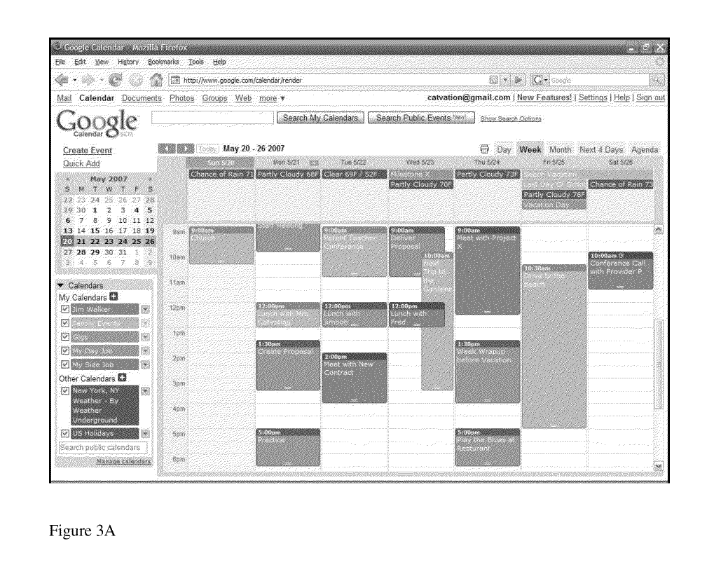

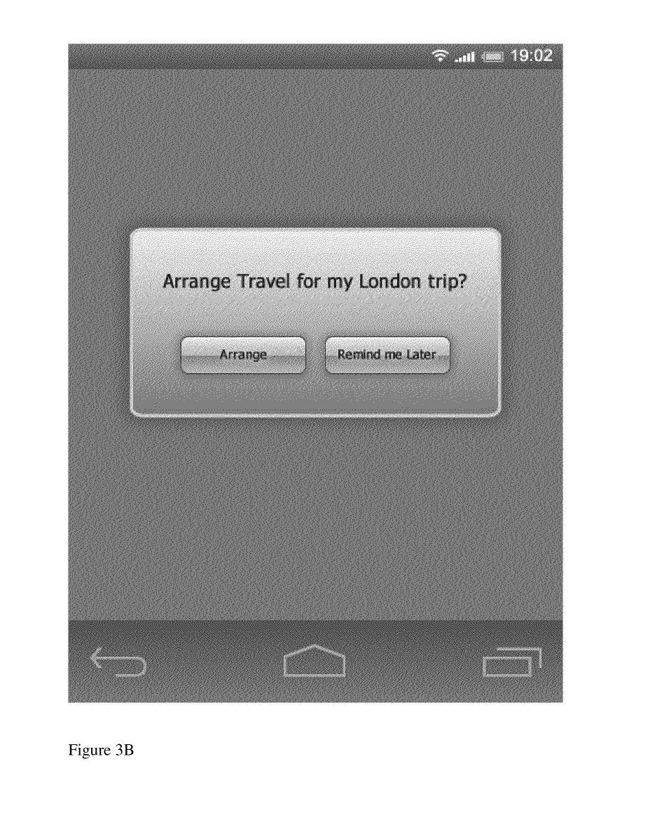

FIGS. 3A and 3B illustrate standard screens for a personal electronic device. Associated with each meeting, there is an icon or electronic button. Generally, it will be next to or at least near the icon. Clicking on that icon or electronic button starts the booking process. It may be appreciated that the icon may be anywhere on the screen. Its location is not material to the invention.

In response to only a single action being performed, designating a meeting with a specified physical location on an electronic calendar for making travel arrangements. This involves “clicking” the icon or electronic button associated with the meeting. Upon this “one click” a whole series of actions start, and all are independent of the user. They all take place in the background without further user participation. A voice command, as is known, may also be used to activate the process.

First, it must be determined if there is time to even get to the meeting (based on other meetings in the calendar) and are travel services available at those times.

The system identifies existing meetings entered on the electronic calendar that are closest in time to the designated meeting, and then identifies from the electronic calendar the location of the user for days immediately before and after the designated meeting.

In order to determine if there is time to get to the designated meeting, there needs to be a point of reference. Where is the immediate preceding meeting? Where is the next meeting? For example, if a person has a meeting at 9 am on Monday in Jerusalem and a 3 pm meeting in Tel Aviv that same day, the system calculates that he obviously cannot go to a meeting in London at 12 Noon on that same day. Even though the time slot is open, there is insufficient time to make the travel connections back and forth.

Another aspect is checking the physical location of the user on the immediate prior day and the subsequent day. For example, if a person is in New York on Monday and Chicago on Wednesday, even though all day Tuesday may be open for meetings, the system computes that there is not sufficient time to go back and forth and have meetings in Hong Kong on that intervening Tuesday.

The system thus calculates travel time to and from the designated meeting from immediately preceding and immediately succeeding existing meetings and from the locations for the days immediately before and after the designated meeting. In this way it determines if the designated meeting is even physically possible.

Thus, the next step is for the system to determine if there is sufficient time to travel to and from the physical location of the designated meeting.

In the event there is inadequate time, the user is advised that the meeting is not possible.

Assuming, there is adequate time to travel, the next issue is whether there are transportation services at that time of day. For example, if it takes 10 hours door to door to travel to London and your calendar shows an open slot for travel of 15 hours, though this may seem adequate, it is dependent on flight schedules. If flights do not leave during this time slot, then the trip is not possible, even thought theoretically there is time.

Hence, the system determines if there is availability of transportation services at a time needed for travel.

If there is sufficient time to travel to and from the designated meeting and transportation services are available, now the system moves to automatically making travel arrangements without further user involvement.

In the event, there is insufficient time to travel to and from the designated meeting and/or insufficient transportation services, the system advises the user that the designated meeting is not logistically possible.

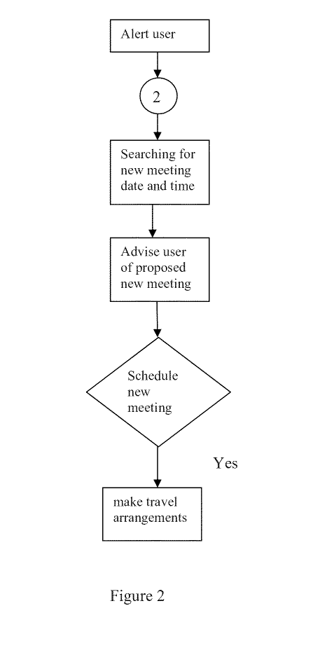

According to a preferred embodiment, if the designated meeting is not logistically possible, the system (FIG. 2) searches the electronic calendar for a time and date wherein there is sufficient time and transportation services to travel to the physical location of the designated meeting.

As shown in FIG. 2, after alerting a user that a meeting is not logistically possible, the system searches the calendar for a day and time at which the meeting can be held and where there is sufficient time to travel and transportation services are available at the necessary time. The system may then alert the user of the possible new date. If the user accepts this new meeting, then the system permanently enters it in the electronic calendar and makes the travel arrangements.

Assuming the system is making travel arrangements, as part of that automatic service, it books the physical location for the designated meeting. For example, if the meeting is in a club or hotel, the facility is contacted electronically and the booking is made.

As part of booking the meeting location, the system may also book amenities for the designated meeting. Amenities may include refreshments, for example. In some cases it may require equipment, such as video conferencing equipment, pads and pencils, computers, video recorders, televisions and a whole myriad of meeting related necessities.

Automatically making travel arrangements includes booking transportation services, which generally means the common carrier. Therefore, booking transportation services includes, but is not limited to, inter alia plane tickets, boat tickets, bus tickets, train tickets, car rental, limousine rental and/or taxi tickets.

Making travel arrangements includes booking lodging which typically includes hotel reservations and/or restaurant reservations.

The process of automatically making travel arrangements includes making travel arrangements is preferably based on pre-entered user preferences and/or prior selections. In particular, each user will ideally create a preference file on his personal electronic device. This may include such information as inter alia airline preference, seat and meal preference, credit card information, frequent flyer number, hotel preference, etc. The user may insert any travel details in order to facilitate the booking of travel arrangements. In addition, the system may make booking based on prior selections. For example if all prior travel was on El Al, the system may continue to book on El Al. If the user always stays at Leonardo hotels, the system will give preference to booking Leonardo hotels.

Another aspect of the invention is that it can be programmed to leave time before the designated meeting for other activities. For example, if a person had an International plane flight, the system can leave time after the flight and before the meeting to check into the hotel, shower and dress. Time may be allocated for eating or for Religious services. Another option is to leave time for reviewing materials prior to a meeting. Time may even be set aside for a nap.

In a preferred embodiment, the system can alert a user that he has not yet made reservations.

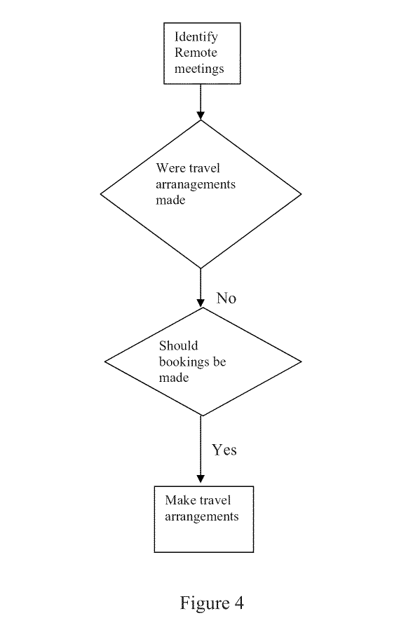

More particularly (FIG. 4), this part of the method additional includes: identifying meetings on the electronic calendar in physical locations remote to the user; if travel arrangements have not been made for these identified meetings within a pre-specified time prior to the meeting, generating a “pop up” reminder to the user; then the user indicates on the pop up reminder if travel arrangements should be made; and if the user indicates that travel arrangements should be made, automatically making the travel arrangements without further user involvement.

Periodically, the system searches through the calendar to identify meetings in remote locations with no travel arrangements. The user can set his system for whatever frequency he wants this search to be done, or there can even be an option to manually start the search. Such a search can be done weekly, every 10 days or at whatever frequency the user requires and desires.

Since the electronic calendar includes physical locations for each meeting and a default home location for the user, it can determine meetings which require travel, either because they are remote from the home location or because they are physically remote from the adjacent meetings on the calendar.

Upon identifying remote meetings with no travel arrangements, the system generates a pop up reminder to advise the user. The user can then click on the pop up reminder and the system will then automatically make the travel arrangements as explained hereinabove. Alternately, the user can indicate that no travel plans be made at this time.

Another embodiment integrates global positioning technology (e.g. GPS) into the system for making reservations. By means of GPS technology, the location of the user is easily determined by determining the location of his personal electronic device. Then the system calculates travel time from the current location and determines if the user can still make the booked travel. If not, the travel is re-booked.

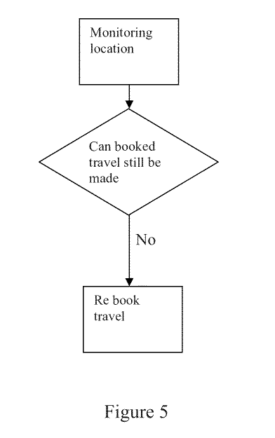

As shown in FIG. 5, the method further includes: monitoring a physical location of the user (as by GPS or similar means); determining if the user can still make it to the booked transportation services, based on the user's current physical location; and re-booking the transportation services to the physical location of the designated meeting if the user can no longer make the booked transportation services.

Still another variation of the invention involves instant reservations. For example, a person needs a hotel or restaurant immediately. He can just “one click” an icon or electronic button on the screen of his personal electronic device to start the process; or, he may use a voice command to activate the process. By means of GPS technology the device knows the current location. Then a search is done of the closest hotels (or restaurants or other facilities) and the booking is automatically made.

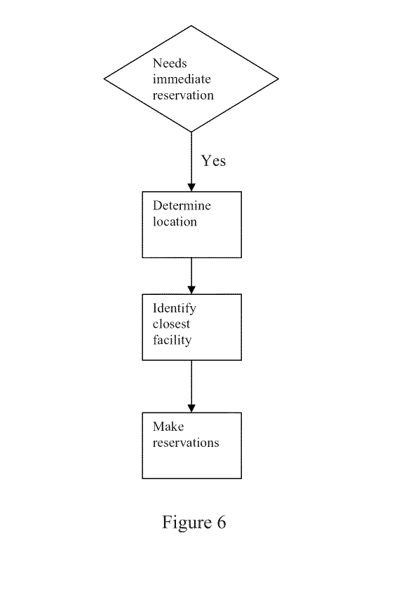

As shown in FIG. 6, this method for making immediate reservations includes: in response to only a single action being performed, a user identifies a need for immediate reservations; identifying a physical location of the user; identifying facilities within a defined distance of the user; and making reservations for said user at a selected facility.

According to this embodiment of the method, monitoring a physical location of the user includes using a global positioning system to determine a physical location of a personal electronic device of the user.

Reservations can thus be made for any facility, including, but not limited to, hotel rooms and/or restaurants.

Another aspect involves ordering local transportation. This may be done at the end of a meeting and/or in advance of a meeting. Since meetings are entered on the user's electronic calendar, the device knows when a meeting is scheduled to end or to begin. At a predetermined time prior to a meeting ending (or prior to a meeting starting) the device generates a Pop Up reminder to the user to inquire if local transportation is needed. If the user indicates yes, then local transportation, such as a taxi, is ordered to meet the user at his current location.

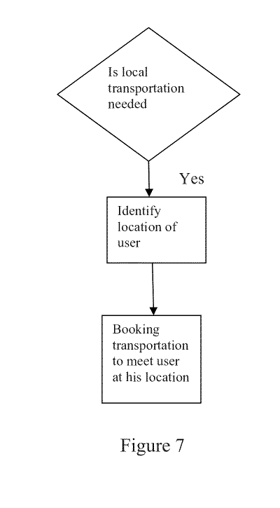

As shown in FIG. 7, this method for making immediate reservations includes: automatically generating a “pop up” reminder to a user; the user specifying if local travel services are required; identifying a physical location of the user; and, automatically booking local travel services to pick up the user at the physical location of the user

According to this embodiment of the method, identifying a physical location of the user includes using a global positioning system to determine a physical location of a personal electronic device of the user.

Automatically generating a “pop up” reminder to a user may be done at a preselected amount of time prior to an ending of a meeting entered in an electronic calendar of said user or at a preselected amount of time prior to a beginning of a meeting entered in an electronic calendar of said user.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. A method of making travel arrangements, comprising:
A. In response to only a single action being performed, designating a meeting with a specified physical location on an electronic calendar for making travel arrangements;
B. Identifying existing meetings entered on said electronic calendar that are closest in time to a designated meeting;
C. Identifying from said electronic calendar a location of said user for days immediately before and after said designated meeting;
D. Calculating travel time to and from said designated meeting from immediately preceding and immediately succeeding existing meetings and from said locations for said days immediately before and after said designated meeting;
E. Determining if there is sufficient time to travel to and from said physical location of said designated meeting;
F. Determining if there is availability of transportation services at a time needed for travel; and
G. If there is sufficient time to travel to and from said designated meeting and transportation services are available, automatically making travel arrangements without user involvement.

2. A method according to claim 1, further comprising: if there is insufficient time to travel to and from said designated meeting and/or insufficient transportation services, advising said user that said designated meeting is not logistically possible.

3. A method according to claim 2, further comprising searching said electronic calendar for a time and date wherein there is sufficient time and transportation services to travel to said physical location of said designated meeting.

4. A method according to claim 1, further comprising booking amenities for said designated meeting.

5. A method according to claim 1, further comprising booking said physical location for said designated meeting.

6. A method according to claim 1, wherein automatically making travel arrangements includes booking transportation services.

7. A method according to claim 6, further comprising:
A. Monitoring a physical location of said user;
B. Determining if said user can still make it to booked transportation services, based on said user's current physical location; and
C. Re-booking said transportation services to said physical location of said designated meeting if said user can no longer make said booked transportation services.

8. A method according to claim 7, wherein monitoring a physical location of said user includes using a global positioning system to determine a physical location of a personal electronic device of said user.

9. A method according to claim 6, wherein booking transportation services includes plane tickets, boat tickets, bus tickets, train tickets, car rental, limousine rental and/or taxi tickets.

10. A method according to claim 1, wherein automatically making travel arrangements includes booking lodging.

11. A method according to claim 10, wherein booking lodging includes hotel reservations and/or restaurant reservations.

12. A method according to claim 1, wherein automatically making travel arrangements includes making travel arrangements based on pre-entered user preferences and/or prior selections.

13. The method of claim 1 wherein the single action is clicking an icon or an electronic button or a voice command.

14. The method according to claim 1, further comprising:
A. Identifying meetings on said electronic calendar in physical locations remote to said user;
B. If travel arrangements have not been made for identified meetings within a pre-specified time prior to the meeting, generating a “pop up” reminder to said user;
C. User indicating on said pop up reminder if travel arrangements should be made; and
D. If said user indicated that travel arrangements should be made, automatically making travel arrangements without further user involvement.

15. The method according to claim 1, wherein making travel arrangements includes leaving time before said designated meeting for other activities.

16. A method for making immediate reservations, comprising:
A. In response to only a single action being performed, a user identifying a need for immediate reservations;
B. Identifying a physical location of said user;
C. Identifying facilities within a defined distance of said user; and
D. Making reservations for said user at a selected facility.

17. A method according to claim 16, wherein monitoring a physical location of said user includes using a global positioning system to determine a physical location of a personal electronic device of said user.

18. A method according to claim 16 wherein said reservations are for hotel rooms and/or restaurants.

19. A method according to claim 17, further comprising booking transportation from said physical location of said personal electronic device of said user to said selected facility.

20. The method of claim 16 wherein the single action is clicking an icon or an electronic button or a voice command.

21. A method for making immediate reservations, comprising:
A. Automatically generating a “pop up” reminder to a user;
B. Said user specifying if local travel services are required;
C. Identifying a physical location of said user; and
D. Automatically booking local travel services to pick up said user at said physical location of said user.

22. A method according to claim 21, wherein identifying said physical location of said user includes using a global positioning system to determine a physical location of a personal electronic device of said user.

23. A method according to claim 21, wherein automatically generating a “pop up” reminder to a user being done at a preselected amount of time prior to an ending of a meeting entered in an electronic calendar of said user.

24. A method according to claim 21, wherein automatically generating a “pop up” reminder to a user being done at a preselected amount of time prior to a beginning of a meeting entered in an electronic calendar of said user.
